(19) United States
(12) Patent Application Publication
(10) Pub. No.: US 2026/0355701 A1
(43) Pub. Date: Nov. 12, 2026

(54) FLOW-THROUGH COMPONENT, SYSTEM, AND METHOD FOR THE TREATMENT OF A FLUID

(71) Applicant: Green Ocean GmbH, LICHTENSTEIG (CH)

(72) Inventors: Walter Marte, ULISBACH (CH); Anton Marte, VILLNACHERN (CH); Erich Marte, TURGI (CH)

(21) Appl. No.: 19/139,282

(22) PCT Filed: Dec. 18, 2023
(86) PCT No.: PCT/EP2023/086336

§ 371 Date: Jun. 13, 2025

(30) Foreign Application Priority Data
Dec. 22, 2022 (LU) 503245

(51) Int. Cl. B01F 23/232; B01F 25/433; B01F 25/50; B01F 35/21; B01F 35/221

(52) U.S. Cl. CPC B01F 23/232312; B01F 25/433; B01F 25/50; B01F 35/2132; B01F 35/221

(57) ABSTRACT

A through-flow component (10) is provided for mixing at least one first volume flow and one second volume flow. The through-flow component comprises a main body (20) and a mixing structure (30) arranged within the main body. The first volume flow and the second volume flow flow through the main body in a flow direction. The mixing structure has a plurality of structure elements (40), wherein the plurality of structure elements are in at least partial fluidic contact with at least one of volume flows, the first volume flow or the second volume flow, and wherein at least two of the structure elements are arranged along an inner circumferential direction of the main body.

### RELATED APPLICATIONS

This application claims the benefit of priority of Luxembourg patent application No. LU503245 filed on 22 Dec. 2022. The content of Luxembourg patent application LU 503245 is all incorporated by reference as if fully set forth herein in their entirety.

### TECHNICAL FIELD OF THE INVENTION

The invention relates to a flow-through component for mixing volume flows, a system, and a method for treating a fluid and a computer-implemented method for controlling the system.

### BACKGROUND TO THE INVENTION

Currently established methods for treating wastewater can basically be divided into two groups. The first group of processes merely separates the substances or problematic substances to be disposed of and requires further downstream process stages for their mineralization. Exemplary processes of substance separation such as flotation, filtration, sedimentation, reverse osmosis and evaporation only lead to partial disposal of the substances to be disposed of. The concentrates and sludges resulting from these processes must be finally disposed of in hazardous waste landfills or by incineration.

A second group of processes are oxidation processes such as the technically realized processes ozonation, UV/hydrogen peroxide, UV/iron catalyst/hydrogen peroxide, Fenton process with an iron catalyst and hydrogen peroxide or the ORCAN process with hydrogen peroxide/iron catalyst and atmospheric oxygen. These processes transform the substances to be disposed of into a biocompatible form or oxidize the substances to be disposed of directly to CO2 and water. These processes use auto-oxidation processes that differ significantly in their efficiency due to the specific process conditions.

From the group of oxidation processes for the disposal of organic wastewater constituents, high-temperature wet incineration, which is primarily operated with pure oxygen at 200 to 280 °C, such as the Krupp-KATOX process, has gained technical significance. Another oxidation process is the LOPROX process, which, in contrast to the Krupp-KATOX process, is a low-pressure process. Typical operating conditions for low-pressure processes are pressures of 5 to 20 bar and temperatures below 200 °C. Other low-pressure processes work at pressures between 1 and 5 bar and temperatures in the range of 100 to 150 °C with radical-forming oxidizing agents, preferably hydrogen peroxide.

The aforementioned high-temperature and low-pressure processes usually work under cost-intensive operating conditions and require cost-intensive corrosion-resistant steels and materials. UV-based low-pressure processes (e.g. UV/H2O2, UV/O3, UV/catalyst) only have a limited reaction temperature≤60 °C, can only be applied to particle- or solids-free and transparent wastewater and achieve a low space-time yield compared to other oxidation processes. Ozone-based processes (e.g. O3, O3/H2O2, O3/catalyst) are operated at low temperatures≤40 °C and cause high operating costs with a low space-time yield due to the high energy consumption. Fenton-based processes (e.g. Fenton, Photo/Fenton) only have low operating temperatures of primarily 60 °C, require high catalyst concentrations of 10 mMol/L and higher of an iron salt, have a limited pH range≤3.0 and long reaction times of up to several hours and therefore entail comparatively high operating and investment costs. In comparison, modified Fenton-based processes operated with atmospheric oxygen show higher efficiency with lower operating costs. However, these processes also have a limited pH range≤3.0 due to the use of an iron catalyst, as well as limited air mixing in the nozzle jet despite a jet pipe installed above a nozzle. This results in a higher use of hydrogen peroxide, combined with a decreasing oxidation efficiency with increasing chemical oxygen demand (COD concentration) in the reactor outlet.

The oxidation processes mentioned also have limited applicability due to the phase separation that forms in the reactor during the oxidative mineralization of emulsions and dispersions.

EP 0 937 011 B1 describes a process for the oxidation of wastewater constituents as well as a nozzle system and a plant for carrying out the same. The core of the process is the superposition of three radical chain cycles to form a permanently running reaction chain, which is maintained by incorporating radical starter, catalyst and oxygen into the wastewater stream. Of central importance in terms of reaction technology is the combination of the reaction partners via a nozzle system, which is characterized by the formation of unsteady flow conditions. The nozzle system comprises a reaction nozzle, which is preferably designed as a rotationally symmetrical multiple Laval nozzle.

EP 2 791 067 B1 describes a process for the oxidation of contaminated wastewater, a plant for carrying out the process and a device, in particular a nozzle, for treating wastewater. The nozzle has an outer tube and an inner tube, with an intermediate space being formed between the outer tube and the inner tube. The intermediate space between the outer tube and the inner tube is divided into at least two chambers in the longitudinal direction of the tubes, with the inner tube tapering in the longitudinal direction and widening again, and the inner tube having at least one opening in each chamber at the tapered point. The nozzle is preferably rotationally symmetrical.

However, the prior art does not disclose a system or method for improving the efficiency of the oxidation of substances to be disposed of by improving the mixing of the volume flows involved in the oxidation.

### BRIEF SUMMARY OF THE INVENTION

The invention is based on the technical problem of providing an improved oxidation method for the disposal of substances with better mixing of the volume flows involved in the oxidation.

This technical problem is solved by a flow-through component for mixing volume flows, a system, and a method for treating a fluid and a computer-implemented method for controlling the system. The present document describes a flow-through component for mixing at least a first volume flow and a second volume flow. The flow-through component comprises a base body, through which the first volume flow and the second volume flow flow in one flow direction, and a mixing structure arranged within the base body and having a plurality of structural elements. The plurality of structural elements is at least partially in fluidic contact with at least one of the first volume flow and the second volume flow. At least two of the structural elements are arranged along an inner circumferential direction of the base body.

The mixing structure generates highly dynamic turbulence in the flow-through component, which leads to improved mixing of the first volume flow and the second volume flow. Cavitation effects triggered by the mixing structure within the flow-through component lead to an increase in the interface between the phases of the first volume flow and the second volume flow and thus to increased radical formation.

In addition, at least two of the structural elements can be arranged along the flow direction and the structural elements can be arranged at least partially in a spiral shape along the flow direction. This further promotes the generation of highly dynamic turbulence and cavitation effects.

The structural elements can be arranged along the flow direction at least partially in at least one of a counterclockwise spiral shape and a clockwise spiral shape and the winding ratios of the counterclockwise spiral shape and/or the clockwise spiral shape can correspond to Fibonacci numbers. This further promotes the generation of highly dynamic turbulence and cavitation effects.

The base body can have at least one or more of a cylindrical, conical, hyperbolic and double-cone shape along the flow direction and at least one of the structural elements can have a tetrahedral, parabolic, conical and pyramidal shape. This further promotes the generation of highly dynamic turbulence and cavitation effects.

The mixing structure can at least partially comprise a catalyst compound. This allows a heterogeneously catalyzed reaction to be carried out.

A system for treating a fluid is also described. The system comprises a reactor and a flow-through component according to the invention arranged on the reactor. The system further comprises a nozzle device arranged to feed at least a first volume flow and a second volume flow into the flow-through component.

The nozzle device may comprise a multi-substance nozzle and the reactor may comprise an inner body for generating a reactor-intrinsic recirculation flow, wherein the flow-through component may be arranged at least partially within the inner body.

The system may further comprise a separator device for separating a phase from the reactor, wherein the separator device may comprise at least one of an annular line, an overflow edge or a floating body and wherein the separator device may comprise a suction pump to suck off the phase and return the phase by means of the nozzle device into the flow-through component and/or discharging the phase.

A method for treating a fluid in a reactor with a flow-through component according to the invention is also described. The method comprises the steps of feeding at least a first volume flow and a second volume flow into the flow-through component by means of a nozzle device and mixing the first volume flow and the second volume flow within the flow-through component to promote a reaction chain between the first volume flow and the second volume flow.

The method can further comprise the steps of separating a phase from the reactor by means of a separator device, feeding back the separated phase to the flow-through component by means of the nozzle device and/or discharging the separated phase.

A computer-implemented method for controlling a system for treating a fluid in a reactor with a flow-through component is also described. The method comprises the steps of detecting an actual value of at least one target variable of the system by means of a sensor, determining a control value of at least one control variable from the actual value of the target variable, a target value of the target variable and an actual value of the control variable by means of an optimization algorithm and setting the control variable to the control value by means of a control device contained in the system.

The optimization algorithm can be a gradient method optimization algorithm or an evolutionary strategy optimization algorithm. The at least one target variable can also be a technical or a commercial parameter.

The at least one control variable can be, for example, the pH value of the fluid treated with the system or a dosing value for peroxide, air or catalyst fed to the system.

The at least one target variable can preferably be the chemical oxygen demand (COD concentration), preferably the color or preferably the AOX concentration (adsorbable organically bound halogens) of the fluid fed to the system or the fluid currently contained in the system.

A computer program is also described. The computer program comprises instructions which, when executed by a computer, cause the computer to perform the computer-implemented method according to the invention.

A computer-readable medium is further described. The computer-readable medium comprises instructions which, when executed by a computer, cause the computer to carry out the computer-implemented method according to the invention.

### BRIEF DESCRIPTION OF THE FIGURES

FIG. 1 shows a system for treating a fluid according to a first aspect.

FIG. 2 shows a system for treating a fluid according to a second aspect.

FIG. 3A shows a perspective view of a flow-through component according to a first aspect.

FIG. 3B shows a sectional view of the flow-through component according to the first aspect.

FIG. 3C shows a perspective view of the negative form of a mixing structure of the flow-through component according to the first aspect.

FIG. 3D shows a further sectional view of the flow-through component according to the first aspect.

FIG. 3E shows a perspective sectional view of the flow-through component according to the first aspect.

FIG. 4A-D show different shapes of structural elements of the flow-through component.

FIG. 5A-D show different shapes of base bodies of the flow-through component.

FIG. 6A shows a top view of a nozzle device.

FIG. 6B shows a sectional view of the nozzle device.

FIG. 7A shows a diagram of the kinetics of the oxidative degradation of wastewater constituents according to a first example using the system according to the invention.

FIG. 7B shows a diagram of the kinetics of the oxidative degradation of wastewater constituents according to the first example without the system according to the invention.

FIG. 8A shows a diagram of the kinetics of the oxidative degradation of wastewater constituents according to a second example using the system according to the invention.

FIG. 8B shows a diagram of the kinetics of the oxidative degradation of wastewater constituents according to the second example without the system according to the invention.

FIG. 9 shows a diagram of the kinetics of the oxidative degradation of wastewater constituents according to a third example using the system according to the invention.

FIG. 10 shows a flow diagram of a method for the treatment of a fluid according to the invention.

FIG. 11 shows a flow diagram of a computer-implemented method for controlling the system according to the invention.

### DETAILED DESCRIPTION OF THE INVENTION

The invention will now be described on the basis of the drawings. It is understood that the embodiments and aspects of the invention described herein are examples only and in no way limit the scope of protection of the claims. The invention is defined by the claims and their equivalents. It is understood that features of one aspect or embodiment of the invention may be combined with a feature of another aspect or other aspects and/or embodiments of the invention.

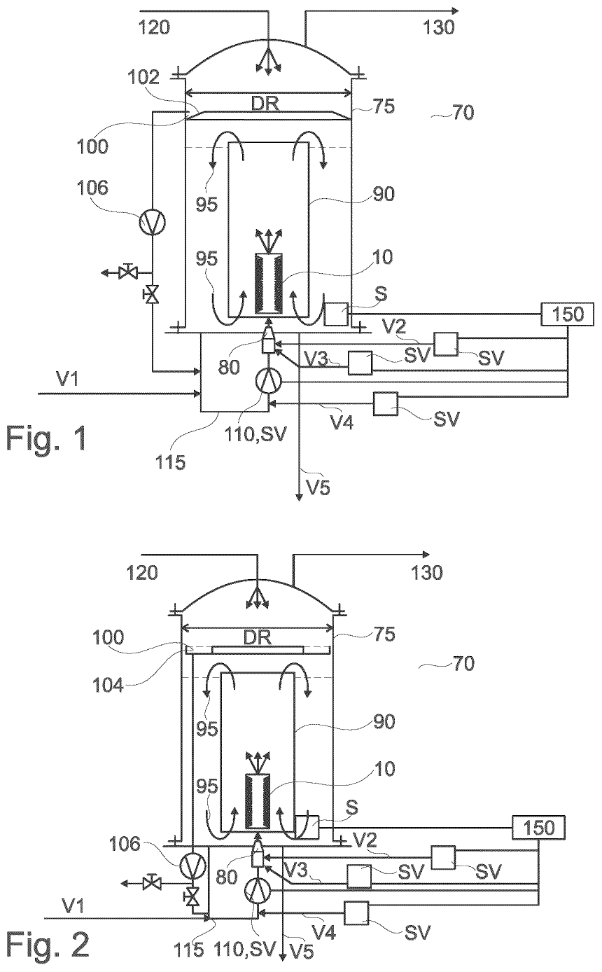

FIG. 1 shows a system 70 for treating a fluid according to a first aspect. The system 70 comprises a reactor 75 having a reactor diameter DR, a flow-through component 10 or booster tube and a nozzle device 80. The reactor may for example comprise a closed vessel. The reactor 75 may have one or more detachable and reattachable parts such as, for example, a lid at the upper end of the reactor 75 and/or a bottom part at the lower end of the reactor 75. The flow-through component 10 and the nozzle device 80 together form a nozzle booster system. The flow-through component 10 is arranged inside the reactor 75, preferably on the bottom side. The nozzle device 80 is arranged in a line or in alignment with the flow-through component 10. The nozzle device directly adjoins the flow-through component 10 in the direction of a flow direction R1 or can be arranged offset from the flow-through component 10 by several diameters of the flow-through component 10 in the direction of the flow direction R1. The flow-through component 10 is configured to be interchangeably arranged in the reactor 75 depending on the fluid medium. The flow-through component 10 is configured not to be fixedly connected to the nozzle device 80 in the reactor 75. In particular, the flow-through component 10 is detachably connected to the nozzle device 80 in order to be replaceable depending on the medium. Since the flow-through component 10 is not fixedly connected to the nozzle device 80, the nozzle device 80, in particular the nozzle device 80 formed as a multi-substance nozzle with external mixture 86, and the flow-through component 10 can operate independently of one another.

The system 70 further comprises an inner body 90, which is arranged within the reactor 75. The flow-through component 10 is arranged at least partially within the inner body 90. The nozzle device 80 may also be arranged at least partially within the inner body. The inner body 90 can be tubular with a circular or oval cross-section, for example, and serves to generate a reactor-intrinsic circulation flow 95.

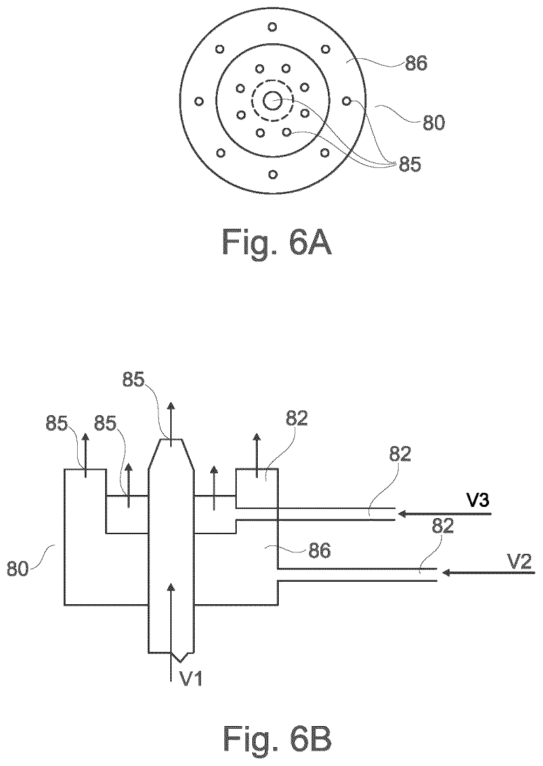

The nozzle device 80 is used to feed one or more volume flows V1 to V4 or fluids into the reactor 75. The nozzle device 80 is described in detail with FIGS. 6A and 6B. The nozzle device 80 is connected to one or more volume flows V1 to V4 and can feed these to the reactor 75 in such a way that the fed volume flows V1 to V4 flow through the flow-through component 10. The volume flows V1 to V4 are mixed as they flow through the flow-through component 10.

A first volume flow V1 is fed to the nozzle device 80 via a circulation pump 110. The first volume flow V1 is, for example, a fluid to be treated with the system 70, such as organically contaminated wastewater. The first volume flow V1 represents the feed of the wastewater into the system 70. The first volume flow V1 is fed to the reactor 75 by means of the nozzle device 80 and flows through the flow-through component 10.

A second volume flow V2 is also fed to the nozzle device 80. The second volume flow V2 is air or pure oxygen or an oxygen-containing gas. The second volume flow V2 is fed to the reactor 75 by means of the nozzle device 80 and flows through the flow-through component 10. The second volume flow V2 can be fed to the nozzle device 80 by means of a pump.

A third volume flow V3 is also fed to the nozzle device 80. The third volume flow V3 is a radical-forming oxidizing agent, preferably hydrogen peroxide. The third volume flow V3 is fed to the reactor 75 by means of the nozzle device 80 and flows through the flow-through component 10. The third volume flow V3 can be fed to the nozzle device 80 by means of a pump.

A fourth volume flow V4 is also fed to the nozzle device 80. The fourth volume flow V4 is a catalyst for homogeneously catalyzing the reactor 75, for example one or a mixture of salts of the transition metals or an organic quinoid/benzoid compound system. The use of organic catalysts with a quinoid/benzoid structure, such as 1,4 benzoquinone and anthraquinone, is used in the pH range from 5 to 11, preferably in the range from 6 to 10. The fourth volume flow V4 is fed to the reactor 75 by means of the nozzle device 80 and flows through the flow-through component 10. The fourth volume flow V4 can be fed to the nozzle device 80 by means of a pump.

A fifth volume flow V5 is removed from the reactor via a discharge line. The fifth volume flow V5 can, for example, discharge any remaining residues from the reactor 75.

Furthermore, a circulation volume flow can be removed from the reactor 75 via a circulation line 115 and re-fed to the reactor 75 via the circulation pump 110 and the nozzle device 80. In this way, wastewater that is already in the reactor 75 can flow through the flow-through component 10 again.

Some of the volume flows described can be omitted. Not all of the described volume flows must necessarily flow through the flow-through component 80. Likewise, not all of the described volume flows must be fed to the reactor 75 by means of the nozzle device 80, but can also be fed to the reactor 75 by other means. Some of the described volume flows can also be mixed upstream of the nozzle device 80 and can be fed together to the nozzle device 80. The described volume flows can be completely unmixed or already partially mixed when they enter the flow-through component 10.

The system 70 also comprises a shower 120, consisting of a shower line and a spray nozzle arranged in an upper part of the reactor 75. The shower 120 can also be used to treat foaming media without interference. The spray nozzle of the shower 120 is fed by a specially installed pump and has a flow rate of 10 to 50 l/min, depending on the volume of the reactor 75.

The system 70 further comprises an exhaust air discharge 130 disposed in an upper part of the reactor 75 for exhausting gases during operation of the reactor 75.

The system 70 further comprises a separator device 100 for separating a water-insoluble phase forming in the reactor 75 on the surface of a fluid present in the reactor, such as an oil phase, and separating the separated oil phase from the reactor 75. Separation and removal of the oil phase may be necessary in particular due to the multiphase nature of various wastewaters (e.g. emulsions and oil-containing dispersions). Emulsions and dispersions are predominantly thermodynamically unstable systems that break down into individual mixed phases at elevated temperatures (<60 °C). The separator 100 adapts to the level of the floating phase in order to remove only the floating phase.

The separator device 100 comprises an overflow edge 102, in particular a flexible overflow edge 102, for separating the oil phase and a suction pump 106 for suctioning or precipitation of the oil phase from the reactor 75. Instead of the overflow edge 102, the separator device 100 can also comprise an annular line, in particular a flexible annular line. The suction pump 106 is configured to suck off the floating phase and feed back the floating phase to the flow-through component 10 by means of the multi-substance nozzle with external mixture 86. Furthermore, the suction pump 106 can be configured to discharge the floating phase.

The separated and precipitated oil phase can either be removed from the system 70 and finally disposed of, for example in hazardous waste landfills or by incineration. This can be particularly expedient for precipitated non-oxidizable oils such as perfluorinated hydrocarbons. Alternatively, the separated and precipitated oil phase can be re-fed into the reactor 75, as can be expedient for precipitated oxidizable oils, for example. The renewed feed can be carried out, for example, by means of the suction pump 106 via the circulation line and the nozzle device 80.

The system further comprises a processor 150 connected to a sensor S or a measuring device and at least one control device SV. The processor 150 may communicate with the sensor S and the at least one control device SV either by means of wired communication and/or by means of wireless communication. The processor may be arranged on the reactor 75 or separately from the reactor 75. The sensor S is arranged in the reactor 75 and is arranged to detect the chemical oxygen demand (COD concentration) of the fluid currently contained in the system 70. Alternatively, the sensor S can detect the chemical oxygen demand of the first volume flow V1 fed to the system 70.

The at least one control device SV is arranged in a feed line of the second volume flow V2, the third volume flow V3 and/or the fourth volume flow V4 and is configured to dose the quantity of the respective volume flow fed to the reactor 75. The control device SV may, for example, be an electrically controllable valve. The circulation pump 110 can also be a control device SV, by means of which the quantity of the first volume flow 75 fed to the reactor can be set.

The system 70 is used to perform an oxidation process for the disposal of organically contaminated wastewater (first volume flow V1) in the reactor 75 with the feed of a radical initiator (third volume flow V3), a catalyst (fourth volume flow V4) and an oxygen-containing gas (second volume flow V2) in a hydrodynamic, highly turbulent motive jet flow.

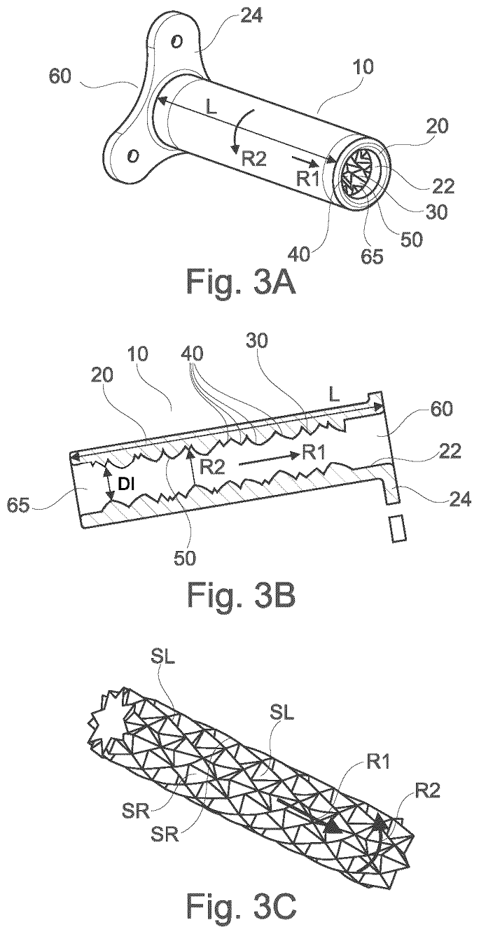

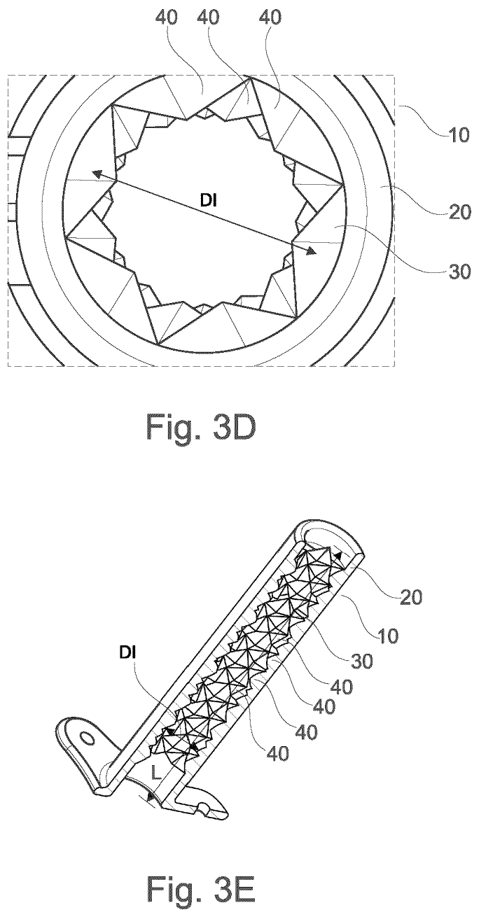

The flow-through component 10 plays an important role in the efficiency of the oxidation process performed with the system 70. The flow-through component 10 is described in detail in FIGS. 3A-3E. The volume flows V1, V2, V3 and V4 are mixed when flowing through the flow-through component 10 by generating highly dynamic turbulence. Pronounced cavitation effects within the flow-through component 10 lead to the increased formation of micro-droplets and thus to an increase in the interface between the liquid and gas phases of the mixed volume flow. The oxidation of the organic wastewater constituents takes place preferentially at the phase boundaries, which is why the increase in the interface between the liquid and gas phases leads to increased radical formation, in particular OH* radicals, and consequently to higher degradation rates of the organic wastewater constituents.

By using a flow-through component 10 in the system 70 as described in detail in FIGS. 3A-3E, the volume flow ratio between the gas phase (second volume flow V2) and the liquid phase (first volume flow V1) can be increased from 2.5 to 6.0, which means that, compared with other Fenton/air processes, wastewater with up to 20% higher COD concentrations can be treated for a given volume of the reactor 75. This results in a decisive advantage of this process, as the consumption of peroxide (third volume flow V3) is reduced by 60 to 70% compared to alternative processes due to the high oxygen utilization rate, which means that operating costs can be reduced by the same amount.

In contrast to existing oxidation technologies, the reactor 75 can be operated as a tubular reactor due to the flow-through component 10 and the nozzle device 80, since the reaction takes place primarily in the flow-through component 10, which means that the reactor 75 only serves as a storage tank.

The reactor 75 is operated at 1 to 10 bar, preferably at 2 to 6 bar. The reaction temperatures range between 60 and 150 °C, preferably between 80 and 120 °C, whereby the operating temperature also depends on the oxidizability of the wastewater constituents.

To achieve a microsuspension to increase the mass transfer between the gas phase and the liquid phase, additional surfactants such as polypropylene/polyethylene oxide co-polymers can be used in the reactor 75, which also have a foam-damping effect. The HLB range (hydrophilic-lipophilic balance) of the surfactants used is between 5 and 15, preferably between 8 and 12.

System 70 can be used to oxidize the entire spectrum of organic compounds (aliphatic, aromatic, heterocyclic, oligomeric and polymeric, particulate and dissolved) until they are biocompatible. In addition, wastewater with low to high COD concentrations can be reduced to a desired concentration (preferably 60-80%) in continuous operation without reactor conversion. The system 70 can be used in any industry, for example for pharmaceuticals, chemicals, textiles, paper, electroplating, leachate and/or wastewater from oil production, etc. The reactor 75 can also be used to carry out processes other than the oxidation processes described.

FIG. 2 shows a system 70 for treating a fluid according to a second aspect. The system 70 according to the second aspect corresponds in large parts to the system 70 according to the first aspect and only the differences to the system 70 according to the first aspect are described.

The separator device 110 of the system 70 according to the second aspect differs from the separator device 110 of the system 70 according to the first aspect, but serves the same purpose. The separator device 110 comprises a floating body 104, in particular a flexible floating body 104, for separating the oil phase and a suction pump 106 to suck off or precipitate the oil phase from the reactor 75. A line from the floating body 104 to the suction pump 106 is designed as an inner discharge in the reactor 75.

The separated and precipitated oil phase can either be removed from the system 70 and finally disposed of, for example in hazardous waste landfills or by incineration. This can be particularly expedient for separated non-oxidizable oils such as perfluorinated hydrocarbons. Alternatively, the separated and precipitated oil phase can be re-fed into the reactor 75, as can be expedient for precipitated oxidizable oils, for example. The re-feeding can be carried out, for example, by means of the suction pump 106 via the circulation line and the nozzle device 80.

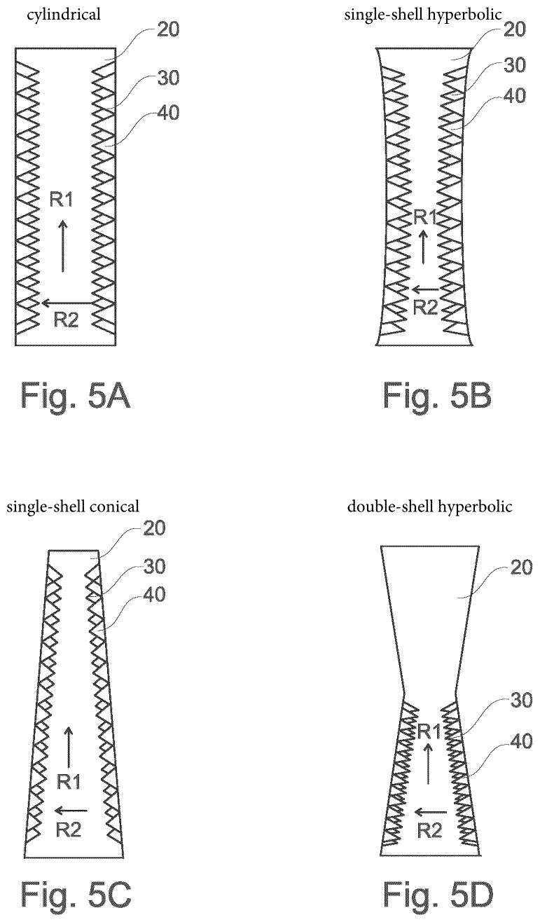

FIG. 3A shows a perspective view of the flow-through component 10 according to a first aspect. The flow-through component 10 comprises a tubular base body 20 of length L with a circular cross-section. The length L of the base body 20 is also the length of the flow-through component 10. The base body 20 can also have a different cross-section, such as a triangular, square or oval cross-section. The shape of the base body 20 is described in more detail in FIG. 5.

The base body 20 has an inlet 60 on one side and an outlet 65 on an opposite side. A fluid can flow through the base body 20 in a flow direction R1, in that the fluid flows into the base body 20 at the inlet 60 and exits again at the outlet 65. The base body 20 can also have several inlets and/or several outlets.

The flow-through component 10 further comprises a mounting structure 24. The mounting structure 24 is connected to the base body 20, but may alternatively be integral with the base body 20. The mounting structure 24 is arranged at one end of the base body 20, but can also be arranged at a different position on the base body 20, depending on the respective conditions at the mounting location. The mounting structure is used to attach or mount the mixing structure 10 to the reactor 75, for example.

The base body 20 has an inner surface 22 on which a mixing structure 30 is arranged. The mixing structure 30 is integral with the base body 20. In other words, the mixing structure 30 can thus be described as a structured inner surface 22 of the base body 20. The mixing structure 30 can alternatively be designed as a separate component and arranged in the base body 20 on the inner surface.

The mixing structure 30 comprises a plurality of separate structural elements 40, wherein the number of structural elements 40 can be varied and is preferably at least two. The structural elements 40 are formed as elevations which rise from the inner surface 22 in the direction of a central axis of the base body 20. Alternatively, the structural elements 40 can also be designed as depressions that extend in an opposite direction.

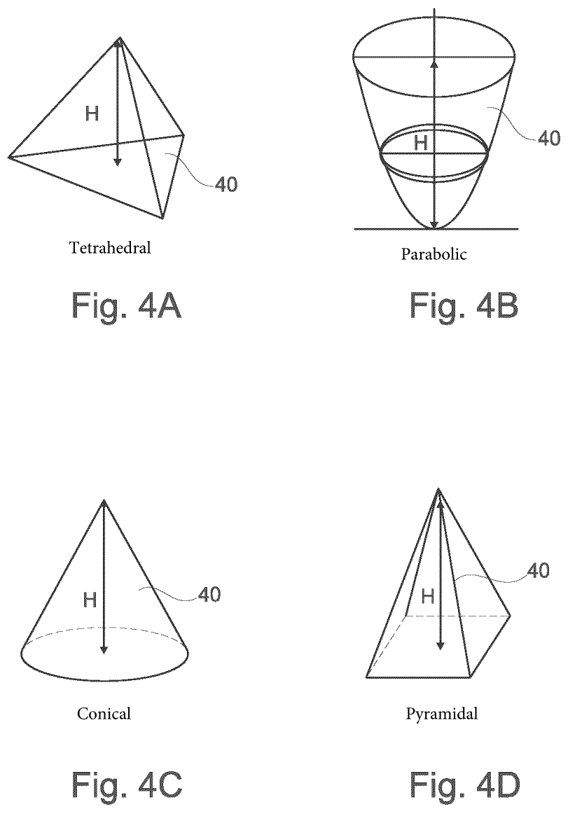

The structural elements 40 are arranged distributed on the inner surface 22, with adjacent structural elements 40 directly adjoining one another. Alternatively, the structural elements 40 can also be arranged at a distance from one another. A plurality of structural elements 40 are arranged in an inner circumferential direction R2, which extends along an inner circumference of the base body 20. Similarly, several structural elements 40 are arranged in the flow direction R1. A detailed description of the arrangement of the structural elements 40 can be found in the description of FIG. 3C. The shape of the structural elements 40 is described in more detail in FIG. 4.

The base body 20, the mounting structure 24 and the mixing structure 30 are made of sintered material or acid-and chemical-resistant stainless steel, preferably of technical ceramic material. The base body 20, the mounting structure 24 and the mixing structure 30 can alternatively be made of other materials which meet the requirements imposed by the wastewater to be treated and the reaction conditions in the reactor 75. The base body 20, the mounting structure 24 and the mixing structure 30 can be made of the same material or of different materials.

The flow-through component 10 is designed as a heterogeneous catalyst. For this purpose, the mixing structure 30 is doped or impregnated with a catalyst compound 50 such as a transition metal oxide or a combination of several transition metal oxides of atomic numbers 21 to 30, 39 to 48, 57 to 80 and 89 to 112. The catalyst compound 50 can also be introduced into or applied to the mixing structure 30 by other manufacturing processes. Several different catalyst compounds 50 can also be used. When used in the acidic pH range, iron compounds and, in the alkaline pH range, manganese compounds are preferably used as catalyst compound 50. The reactor 75 equipped with the flow-through component 10 can thus also be operated in a heterogeneously catalyzed manner.

FIG. 3B shows a sectional view of the flow-through component 10 according to the first aspect. The sectional plane is oriented such that the central axis of the base body 20 lies in the sectional plane. The structural elements 40 of the mixing structure 30 are arranged irregularly. Several structural elements 40 are arranged in the flow direction R1. The mixing structure 30 does not extend over the entire length L of the flow-through component 10, but can also extend over the entire length L. The flow-through component 10 has a mean inner diameter DI. This is calculated from an inner volume of the flow-through component 10 and the length L of the flow-through component 10. The number of structural elements 40, the pitch, in particular the pitch angle, of the structural elements 40 and the height H of the structural elements 40 determine the shape of the resulting structural elements 40.

The mean inner diameter DI is in a range of 5% to 20% of the reactor diameter DR of the reactor 75 in which the flow-through component 10 is used. Preferably, the mean inner diameter DI is 15% of the reactor diameter DR. The length L of the flow-through component 10 is in a range from 5 times to 15 times the mean inner diameter DI. The length L is preferably 12 times the mean inner diameter DI.

FIG. 3C shows a perspective view of the negative mold of a mixing structure 30 of the flow-through component 10 according to the first aspect. The negative mold is used as a mold in the manufacture of the flow-through component 10 and serves to illustrate the arrangement of the structural elements 40.

Viewed in the flow direction R1, the structural elements 40 are arranged in counterclockwise-rotating trains or spiral forms SL and clockwise-rotating trains or spiral forms SR. Individual structural elements 40 are part of more than one counterclockwise spiral form SL and more than one clockwise spiral form SR. The winding ratios of the counterclockwise spiral shapes SL and the clockwise spiral shapes SR correspond to Fibonacci numbers.

The number of counterclockwise spiral shapes SL and clockwise spiral shapes SR, their pitch angle and the height H of the structural elements 40 determine the shape of the resulting structural elements 40. In the example shown, the structural elements 40 have a pyramidal shape. The preferred arrangement of the structural elements 40 shown is characterized by a quotient which is defined by the height H of the structural elements divided by the mean inner diameter DI and is in the range from 0.05 to 0.5, preferably from 0.1 to 0.25.

The described design of the mixing structure 30 through the design and arrangement of the structural elements 40 enables a particularly advantageous mixing of the volume flows V1 to V4 entering the flow-through component 10 at the inlet 60. The structural elements 40 generate highly dynamic turbulence, which leads to the pronounced cavitation effects. In particular, the spiral arrangement of the structural elements 40 generates a rotational movement of the flowing volume flows V1 to V4 around the flow direction R1.

Alternatively, the structural elements 40 can be arranged according to a different scheme or randomly.

FIG. 3D shows a further sectional view of the flow-through component 10 according to the first aspect. The sectional plane is perpendicular to the flow direction R1. A plurality of structural elements 40 is arranged in the inner circumferential direction R2.

FIG. 3E shows a perspective sectional view of the flow-through component 10 according to the first aspect. The sectional plane is oriented such that the central axis of the base body 20 lies in the sectional plane. The sectional view shows the spiral arrangement of the pyramidal structural elements 40.

FIGS. 4A-D show different shapes of structural elements 40 of the flow-through component 10. In addition to the described shape of the structural elements 40 according to the first aspect, the structural elements 40 may also have other shapes. For example, the structural elements 40 can be tetrahedral (FIG. 4A), parabolic (FIG. 4B), conical (FIG. 4C), pyramidal (FIG. 4D) or spherical segment-like. The shapes mentioned can be both symmetrical and asymmetrical. The dimensions of the structural elements 40 can be identical over the entire mixing structure 30, but can also vary. In addition, structural elements 40 of different shapes can be combined in the mixing structure 30.

FIGS. 5A-D show different shapes of the base body 20 of the flow-through component 10. In addition to the tubular or cylindrical (FIG. 5A) shape of the base body 20 described according to the first aspect, the base body 20 can also have other shapes. For example, the base body 20 can be hyperbolic (FIG. 5B), conical (FIG. 5C), but also multi-shelled, for example conical (FIG. 5D). The highly dynamic turbulence of the flowing volume flows V1 to V4 generated within the flow-through component 10 can be further influenced by the choice of shape of the base body 20.

The mixing structure 30 can extend over the entire inner surface 22 of the base body 20 or can only be partially formed on the inner surface 22.

FIG. 6A shows a top view of a nozzle device 80. The nozzle device 80 comprises a multi-substance nozzle 86 with a plurality of openings 85, in the example shown a three-substance nozzle for discharging the first volume flow V1, the second volume flow V2 and the third volume flow V3. The nozzle device 80 can alternatively comprise a single-substance nozzle, a two-substance nozzle or a multi-substance nozzle for dispensing more than three volume flows.

The multi-substance nozzle 86 has a rotationally symmetrical design and the openings 85 are arranged in a uniform annular shape. This results in a homogeneous composition of the total volume flow consisting of the three individual volume flows.

The use of single or multi-substance nozzles depends on the substances contained in the wastewater or fluid to be treated, the pH range suitable for oxidizing the substances and the pH-dependent catalyst system.

FIG. 6B shows a sectional view of the nozzle device 80 designed as a three-substance nozzle. The multi-substance nozzle 86 comprises a feed, a chamber and at least one opening 85 per chamber for each volume flow to be fed. The multi-substance nozzle 86 comprises a feed and a chamber for the first volume flow V1, the second volume flow V2 and the third volume flow V3. Each of the volume flows V1, V2 and V3 enters the respective chamber of the multi-substance nozzle 86 through the respective feed and exits the multi-substance nozzle 86 through the respective at least one opening 85. The multi-substance nozzle 86 shown is a multi-substance nozzle 86 with external mixing, the volume flows V1, V2 and V3 therefore only mix after exiting the openings 85 of the multi-substance nozzle 86. Alternatively, a multi-substance nozzle 86 with inner mixing can also be used, in which the volume flows are already mixed inside the multi-substance nozzle 86.

The first volume flow V1 (wastewater jet) emerges in the center of the multi-substance nozzle 86 and has a flow velocity of 15 to 30 m/s. The third volume flow V3 (peroxide) emerges from annular openings 85, which are arranged adjacent to the first volume flow V1. The second volume flow V2 (air) exits from the outermost annularly arranged openings 85. The multi-substance nozzle 86 shown, which is designed as a three-component nozzle, is preferably suitable for the use of organic catalyst systems with a quinoid/benzoid structure.

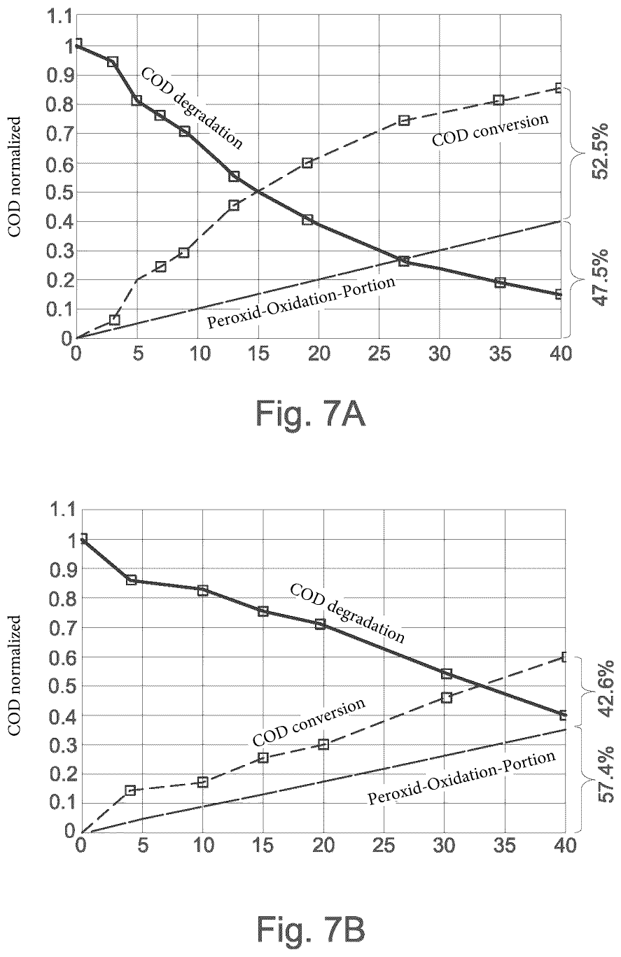

FIG. 7A shows a diagram of the kinetics of the oxidative degradation of wastewater constituents according to a first example with the system 70 according to the invention. The first example describes a system 70 for treating wastewater from chemical synthesis with a COD concentration of 6.5 gO2/L. The structural elements 40 of the flow-through component 10 are designed as pyramidal protrusions, the arrangement of which is based on different counterclockwise windings or spiral shapes SL and clockwise windings or spiral shapes SR. The winding ratio between counterclockwise spiral forms SL and clockwise spiral forms SR is 1.6 and corresponds to the Fibonacci number ratio of 8 to 5.

The reactor 75 is a 5.0-liter reactor and, in addition to standard fixtures, comprises the combination of nozzle device 80 and flow-through component 10 with cylindrical base body 20 according to the invention. The reactor is fed with 3.5 liters of wastewater from a chemical synthesis. The wastewater has a COD concentration of 6.1 gO2/L. The pH value is set to 2.6, 1.5 mMol/L FeSO4* 7 H2O is added and the reaction solution is heated to 105 °C. After setting the pressure to 3 bar and reaching 105 °C, the experiment starts with the addition of 15% hydrogen peroxide (third volume flow V3) at a dosing rate of 2.0 cm3/min for a period of 40 minutes. The 100% hydrogen peroxide mass added to oxidize the substances in the wastewater corresponds to a redox equivalent of 0.35 (moles of peroxide per mole of COD) in relation to the COD value.

At the same time, an air flow (second volume flow V2) of 4.3 NL/min air is fed to the reactor 75 for a period of 40 minutes via the nozzle device 80 and the flow-through component 10. The pH value is kept constant at the predetermined pH value of 2.6 using a controlled system. After a reaction time of 40 minutes, a COD degradation of 83% is determined. The 85% degradation is the result of the peroxide-related COD degradation of 47.5% and the oxygen-related COD degradation of 52.5%, which at this level is due to the use of the nozzle device 80 and the flow-through component 10. The residual substances remaining after oxidation show a degree of biodegradation characterized by a BOD5/COD ratio of 0.76 (BOD5: biological oxygen demand after five days), which ensures trouble-free biodegradation in a municipal wastewater treatment plant.

FIG. 7B shows a diagram of the kinetics of the oxidative degradation of wastewater constituents according to the first example without the system 70 according to the invention. An analogous test with a system which, in contrast to the system 70 according to the invention, was equipped only with a two-substance nozzle instead of the combination of nozzle device 80 and flow-through component 10, resulted in a COD conversion of only 61%, with 57.4% of the COD degradation being carried out by peroxide and only 42.6% by atmospheric oxygen. The comparison of the two test results and the degradation rates shown in FIGS. 7A and 7B shows the improvement in the oxidative degradation of the constituents of the wastewater achieved by the present invention.

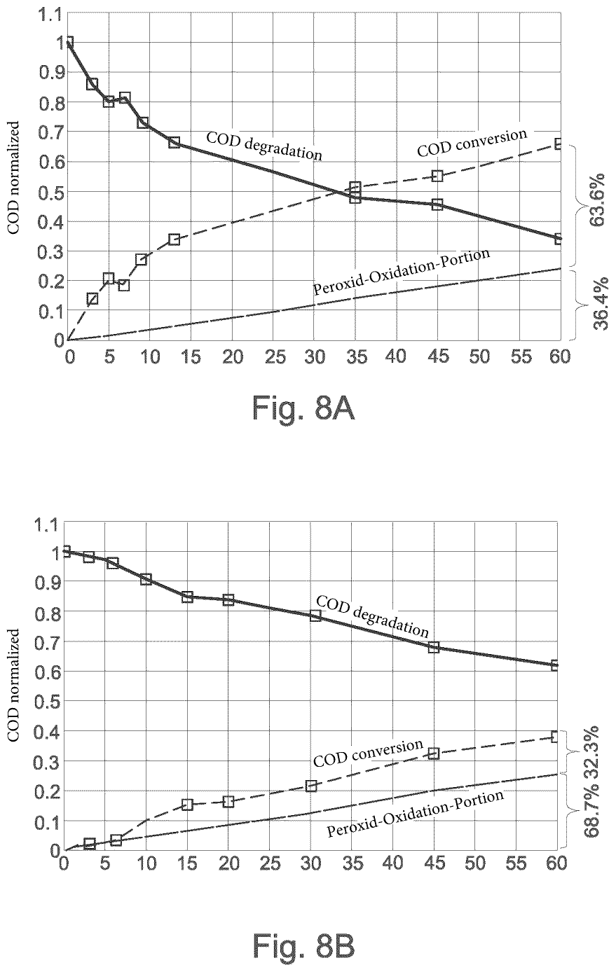

FIG. 8A shows a diagram of the kinetics of the oxidative degradation of wastewater constituents according to a second example with the system 70 according to the invention. The second example describes a system 70 for the treatment of wastewater from the cosmetics industry with a COD concentration of 3.7 gO2/L. The wastewater is a dispersion of unknown composition, which is produced during stirred tank cleaning. The biodegradability of the substances contained in the wastewater is very poor and shows a BOD5/COD ratio of only 0.32. A BOD5/COD ratio of ≥0.6 should be achieved in order to ensure trouble-free operation of a biological wastewater treatment plant.

The base body 20 of the flow-through component 10 is hyperbolic in shape in order to maximize the mass transfer between the gas/liquid/solid phase or to transfer it into a suspension. The structural elements 40 of the flow-through component 10 are designed as tetrahedral protrusions, the height H of which is 25% of the mean inner diameter DI of the flow-through component 10. The structural elements 40 are arranged on 13 counterclockwise windings or spiral forms SL and 8 clockwise windings or spiral forms SR. The winding ratio between counterclockwise spiral forms SL and clockwise spiral forms SR thus corresponds to the Fibonacci number ratio of 13 to 8.

In order to achieve biocompatibility of the constituents of the wastewater, 3.5 liters of the wastewater are set to pH 2.8, mixed with 2.0 mMol/L iron(II) sulphate and heated to 110 °C. The reactor pressure is 3 bar. An 8.1% hydrogen peroxide solution (third volume flow V3) is then added at a rate of 1.5 cm3/min and air (second volume flow V2) at a rate of 2.8 NL/min for 60 minutes using the nozzle device 80 and the flow-through component 10.

In the given case, a COD degradation of 66% was achieved, whereby the required biocompatibility with a BOD5/COD ratio of 0.68 was also achieved. The COD degradation achieved by peroxide in this example is 36.4% and the oxygen-induced degradation is 63.6%. The high hydrodynamic turbulence and cavitation effects prevailing in the flow-through component 10 result in a high mass transfer between the forming phases. This is also associated with the high degree of conversion achieved.

FIG. 8B shows a diagram of the kinetics of the oxidative degradation of wastewater constituents according to the second example without the system 70 according to the invention. An analogous test with a system which, in contrast to the system 70 according to the invention, was only equipped with a two-substance nozzle instead of the combination of nozzle device 80 and flow-through component 10, resulted in a conversion of only 38% due to the phase separation taking place in the reactor. The COD degradation caused by the hydrogen peroxide is 68.7% and that caused by the fed atmospheric oxygen is only 32.3%.

The comparison of the two test results and the degradation rates shown in FIGS. 8A and 8B shows the improvement in the oxidative degradation of the constituents of the wastewater achieved by the present invention.

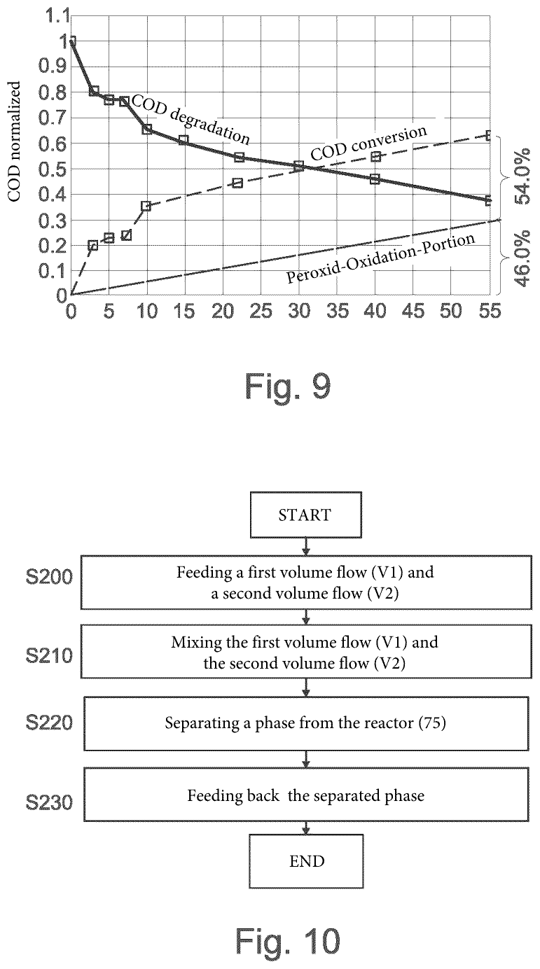

FIG. 9 shows a diagram of the kinetics of the oxidative degradation of wastewater constituents according to a third example with the system 70 according to the invention. The second example describes a system 70 for treating mixed wastewater consisting of wastewater from various branches of industry, such as that produced by waste disposal companies. The mixed wastewater to be disposed of has a COD concentration of 7.3 gO2/L. The substances contained in the wastewater are not biodegradable. The BOD/COD ratio is only 0.24 and cannot be fed into a biological treatment plant.

The aim of wastewater treatment is to ensure that the substances contained in the wastewater are biodegradable. A particular problem with this type of wastewater is the separation into an oil and water phase that occurs at higher temperatures. As a result, the oil phase floating in the reactor is no longer accessible for oxidation. The solution to this problem is the separation and precipitation of the oil phase according to the invention by means of the separator 100 and the re-feeding into the reactor.

The base body 20 of the flow-through component 10 is cylindrical. The system 70 also comprises the separator device 100. The structural elements 40 of the flow-through component 10 are tetrahedral in design and are arranged on 13 counterclockwise windings or spiral forms SL and 8 clockwise windings or spiral forms SR. The winding ratio between counterclockwise spiral forms SL and clockwise spiral forms SR thus corresponds to the Fibonacci number ratio of 13 to 8. The quotient of the height H of the structural elements and the mean inner diameter DI of the flow-through component 10 is 0.12.

For the oxidative treatment of this wastewater, 3.5 liters of the wastewater are set to a pH value of 3.1, mixed with 4.0 mMol/L iron(II) chloride and heated to 110 °C Irreversible phase separation already occurs during heating. The reactor pressure is 3 bar. After heating is complete, hydrogen peroxide is dosed (third volume flow V3) with 2.0 cm3/min of a 16.8% solution for 55 minutes and the oil phase that forms is extracted by means of the separator device 110. The separated oil phase is re-fed to the reactor 75 via the circulation line 115, the nozzle device 80 and the flow-through component 10. The oil/water flow re-fed to the reactor 75 by the separator device 110 is at most 10% of the circulation flow, in the given case 0.05 L/min.

During the 55-minute reaction, 5.5 NL/min of air (second volume flow V2) is fed to the reaction mixture by means of the nozzle device 80 and the flow-through component 10. The air/liquid volume flow ratio in the flow-through component 10 is 3.0 at 3 bar. Without the mixing component 10, only air/liquid volume flows<2.0 at 3 bar pressure lead to adequate mixing of the two phases and to acceptable conversion values. In the given case, a COD conversion of 62% was achieved with an air/liquid volume flow ratio of 3.0 and oil recirculation, resulting in a BOD5/COD ratio of 0.67.

Of the 62% COD conversion rate achieved, 46% is due to the amount of peroxide used and 54% to the atmospheric oxygen added. Complete mineralization takes place in a biological wastewater treatment plant.

FIG. 10 shows a flow diagram of a method 200 for treating a fluid according to the invention. The fluid may be organically contaminated wastewater which is to be oxidized by the method. However, the method can also be used to treat other types of fluid.

In a step S200, a first volume flow V1 and a second volume flow V2 are fed to a reactor 75 by means of a nozzle device 80 and a flow-through component 10. The first volume flow V1 and the second volume flow V2 are mixed in a step S210 during the flow through the flow-through component 1. The mixing is facilitated by a mixing structure 30 arranged within the flow-through component 10. In addition to the first volume flow V1 and the second volume flow V2, further volume flows can also be fed and mixed.

A phase settling in the reactor 75, such as an oil phase, is separated and precipitated in a step S220 by means of a separator device 110. The separated phase is re-fed into the reactor 75 in a step S230 in order to be able to subject it to renewed treatment.

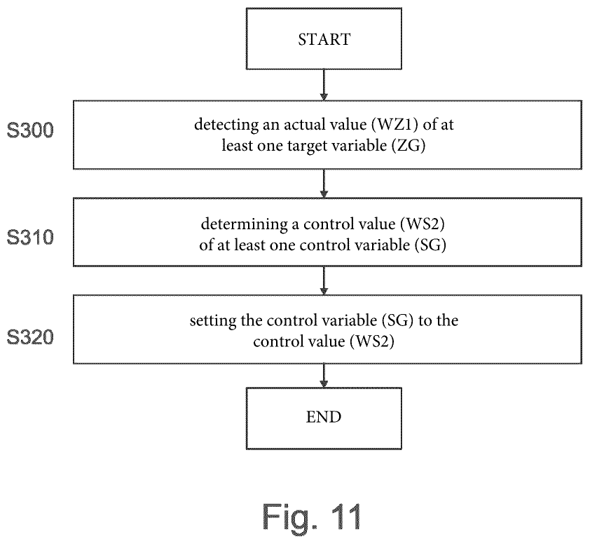

FIG. 11 shows a flow diagram of a computer-implemented method 300 for controlling the system 70 according to the invention. The system 70 can be controlled by the computer-implemented method 300s in such a way that the process of treating a fluid can be adapted dynamically to changing parameters of the fluid introduced into the system 70 or of the fluid discharged from the system 70.

Due to the changing constituents of the fluids or wastewater to be treated and the associated different disposal targets, standard regulation and control algorithms are not sufficient to meet the required wastewater treatment targets and the associated limit values for the wastewater load. The computer-implemented method 300 according to the invention, comprising a program with the functions, can operate the wastewater treatment process in the system 70 according to the invention in a self-dynamic manner, in a previously defined multi-dimensional optimum range.

In a step S300, an actual value WZ1 of at least one target variable ZG is detected by means of a sensor S. The at least one target variable ZG is the COD concentration of the fluid fed to the system 70 or of the fluid currently contained in the system 70. The at least one target variable ZG can alternatively be another technical parameter such as the AOX concentration or the color or a commercial or business parameter such as the operating costs or a combination of technical and commercial parameters. The sensor S is configured to detect the COD concentration. The sensor S can alternatively be configured to detect other technical or commercial parameters. The detection of the actual value WZ1 by the sensor S can be replaced by another determination of the actual value WZ1, e.g. by taking a sample and determining the respective parameter by examining the sample.

In a step S310, a control value WS2 of at least one control variable SG is determined by means of an optimization algorithm. The optimization algorithm determines the control value WS2 of the at least one control variable SG from the actual value WZ1 of the target variable ZG, a target value WZ2 of the target variable ZG and an actual value WS1 of the control variable SG. The optimization algorithm can include further parameters for determining the control value WS2.

The control variable SG is the pH value of the fluid or wastewater treated with the system 70 or a dosing value for the peroxide (third volume flow V3), air (second volume flow V2) or catalyst (fourth volume flow V4) fed to the system 70 or the reactor 75 by means of the nozzle device 80 and the flow-through component 10. The control variable SG can also be other parameters of the system 70 that can be influenced, such as the temperature or the reactor feed flow.

In a step S320, the control variable SG is set to the control value WS2 by means of a control device SV contained in the system 70. The control device SV may, for example, be a pump which conveys one of the second volume flow V2, the third volume flow V3 or the fourth volume flow V4 and can thus be controlled for dosing the volume flows V2 to V4. The control device SV can also be another device for influencing control variables SG of the system 70, such as a control device for the wastewater feed flow and thus the hydrodynamic residence time or heating elements.

More than one target variable ZG can also be considered and more than one control variable SG can be influenced. In this case, the system 70 can comprise more than one sensor S and more than one control device SV. This results in a multidimensional optimization space in which an optimum combination of the control variables SG to be influenced is to be found.

The optimization algorithm is an evolution strategy optimization algorithm. Evolution strategy optimization algorithms belong to the stochastic, metaheuristic optimization methods and are based on the evolution of natural organisms. Five groups of evolution strategy algorithms are commonly distinguished, namely genetic algorithms, evolutionary strategies, genetic programming, differential evolution and evolutionary programming. The optimization algorithm according to the present aspect is an algorithm of the group genetic algorithms.

The search for a solution (i.e. the control value WS2 of at least one control variable SG for which the target value WZ2 of the target variable ZG is achieved) or a solution space (combination of control values in the case of several control variables SG for which the target value WZ2 of the target variable ZG or the target values in the case of several target variables ZG are achieved in the best possible way) is modeled on the natural process of evolution taking place in the environment. Darwin's theory of the evolution of species is taken into account. The starting point is a large number (population) of individuals, with each individual representing a potential solution to the problem. The problem to be solved is defined by a target (or fitness) function. Each individual is assigned a so-called fitness, according to which each individual is evaluated. The fitness represents how well the respective individual fulfills the fitness function.

The two operations mutation, crossover and selection are applied to the individuals in the population. Mutation involves randomly changing the values of individual control variables SG. In crossover, values of individual control variables SG of two individuals are exchanged. In selection, a new population of individuals is formed by selecting individuals from the existing population. The individuals with the best fitness values are selected.

For each population, individuals are changed by mutation and crossover and new individuals are created. A new population of individuals is then created through selection. Mutation and crossover are again applied to this new population and another new population is created by selection. The algorithm carries out this procedure until a termination criterion is met. The termination criterion in the present case is defined in the form of a maximum number of populations to be generated. The maximum number is 100 generations.

In the simplest case of the present optimization algorithm with only one target variable ZG and only one control variable SG, the fitness function consists of the target variable ZG. The individuals of the populations only differ in their value of the control variable SG.

The optimization algorithm can alternatively be another type of evolutionary strategy optimization algorithm, a gradient method optimization algorithm or another type of optimization algorithm.

### REFERENCE SIGNS

10 flow-through component
20 base body
22 inner surface
24 mounting structure
30 mixing structure
40 structural element
50 catalyst connection
60 inlet
65 outlet
70 system
75 reactor
80 nozzle device
82 feed
85 opening
86 multi-substance nozzle
90 inner body
95 circulation flow
100 separation device
102 overflow edge
104 floating body
106 suction pump
110 circulation pump
115 circulation line
120 shower
130 exhaust air discharge
150 processor
200 process
300 computer-implemented process
DI mean inner diameter flow-through component
DR reactor diameter
L length
R1 flow direction
R2 inner circumferential direction
S sensor
SG control variable
SL counterclockwise spiral shape
SR clockwise spiral shape
SV control device
V1 first volume flow
V2 second volume flow
V3 third volume flow
V4 fourth volume flow
V5 fifth volume flow
WS1 actual value
WS2 control value
WZ1 actual value
WZ2 target value
ZG target variable
S200 feeding
S210 mixing
S220 separating
S230 re-feeding
S240 discharging
S300 detecting
S310 determining
S320 setting

1. A flow-through component for mixing at least a first volume flow and a second volume flow, the flow-through component comprising:
a base body through which the first volume flow and the second volume flow flow in a flow direction; and
a mixing structure arranged within the base body and having a plurality of structural elements, wherein
the plurality of structural elements is at least partially in fluidic contact with at least one of the first volume flow and the second volume flow, and wherein
at least two of the structural elements are arranged along an inner circumferential direction of the base body; and wherein
at least two of the structural elements are arranged along the flow direction, wherein the structural elements are arranged along the flow direction at least partially in at least one of a counterclockwise spiral shape and a clockwise spiral shape.

2. The flow-through component according to claim 1, wherein the shape of the structural elements is determined by the number of structural elements, the pitch of the structural elements and the height of the structural elements.

3. (canceled)

4. (canceled)

5. (canceled)

6. The flow-through component according to claim 1, wherein winding ratios of the counterclockwise spiral shape and/or the clockwise spiral shape correspond to Fibonacci numbers.

7. The flow-through component according to claim 1, wherein the base body has at least one or more of a cylindrical, conical, hyperbolic and double-cone shape along the flow direction.

8. The flow-through component according to claim 1, wherein at least one of the structural elements has one of a tetrahedral, parabolic, conical and pyramidal shape.

9. The flow-through component according to claim 1, wherein the mixing structure at least partially comprises a catalyst compound.

10. A system for treating a fluid, the system comprising:
a reactor;
a flow-through component according to claim 1 arranged on the reactor; and
a nozzle device, configured to feed at least a first volume flow and a second volume flow into the flow-through component.

11. A system for treating a fluid, the system comprising:
a reactor;
a flow-through component arranged on the reactor; and
a nozzle device arranged to feed at least a first volume flow and a second volume flow into the flow-through component, wherein the nozzle device comprises a multi-substance nozzle with external mixing.

12. The system according to claim 11, further comprising:
a separator device for separating a phase from the reactor, wherein the separator device comprises at least one of an annular line, an overflow edge or a floating body and wherein the separator device comprises a suction pump for suctioning the phase and returning the phase by means of the nozzle device into the flow-through component and/or discharging the phase; and
a control device configured to dose the quantity of the respective volume flow fed to the reactor, the control device setting a control variable to a control value, the control value being determined by means of an optimization algorithm.

13. (canceled)

14. The system according to claim 10, wherein the reactor comprises an inner body for generating a reactor-intrinsic circulation flow, wherein the flow-through component is arranged at least partially within the inner body.

15. The system according to claim 11, further comprising a sensor which is arranged in the reactor and is configured to detect an actual value of at least one target variable; and
a processor configured to determine the control value of the control variable from the actual value of the at least one target variable, a target value of the at least one target variable and an actual value of the control variable by means of the optimization algorithm.

16. (canceled)

17. The system according to claim 11, wherein the control variable is a pH value of the fluid treated with the system or a dosing value for peroxide, air or catalyst fed to the system or the reactor by means of the nozzle device and the flow-through component.

18. The system according to claim 11, wherein the target variable is preferably the chemical oxygen demand, further preferably the color or further preferably the AOX concentration (adsorbable organic bound halogens) of the fluid fed to the system or of the fluid currently contained in the system, in particular the target variable is a technical or a commercial parameter.

19. The system according to claim 11, wherein the optimization algorithm is a gradient method optimization algorithm or an evolutionary strategy optimization algorithm, in particular the evolutionary strategy optimization algorithm is a genetic algorithm.

20. The system according to claim 11, wherein the flow-through component is configured to be interchangeable depending on the medium of the fluid in the reactor, in particular the flow-through component is not fixedly connected to the nozzle device.

21. The system according to claim 11, wherein the separator device adaptively adjusts to the level of the floating phase in order to remove only the floating phase.

22. The system according to claim 12, wherein the suction pump sucks off the floating phase and feeds back the floating phase to the flow-through component by means of the multi-substance nozzle with external mixture.

23. A method for treating a fluid in a reactor having a flow-through component according to claim 1, the method comprising the following steps:
feeding at least a first volume flow and a second volume flow into the flow-through component by means of a nozzle device formed as a multi-substance nozzle with external mixing; and
mixing the first volume flow and the second volume flow within the flow-through component to promote a reaction chain between the first volume flow and the second volume flow wherein the method comprises at least one of the steps of:
separating a phase from the reactor by means of a separator device;
feeding back the separated phase to the flow-through component by means of the nozzle device;
and discharging the separated phase.

24. (canceled)

25. (canceled)

26. (canceled)

27. (canceled)

28. (canceled)

29. (canceled)

30. (canceled)

31. (canceled)

32. (canceled)

33. (canceled)
